(19) United States
(12) Patent Application Publication
(10) Pub. No.: US 2025/0272987 A1
(43) Pub. Date: Aug. 28, 2025

(54) METHOD FOR CREATING HIGH-RESOLUTION ENVIRONMENT MAPS FOR A VEHICLE HAVING AN AUTONOMOUS DRIVING FUNCTION

(71) Applicant: Robert Bosch GmbH, Stuttgart (DE)

(72) Inventor: Juergen Luettin, Renningen (DE)

(21) Appl. No.: 19/051,277

(22) Filed: Feb. 12, 2025

(30) Foreign Application Priority Data
Feb. 28, 2024 (DE) 10 2024 201 831.7

(51) Int. Cl. G06V 20/56; G06V 10/26; G06V 10/764; G06V 10/774; G06V 10/84; G06V 10/98

(52) U.S. Cl. CPC G06V 20/56; G06V 10/26; G06V 10/764; G06V 10/84; G06V 10/993; G06V 10/774; G06V 2201/06

(57) ABSTRACT

A method for creating high-resolution environment maps for a vehicle having an autonomous driving function. The method includes: providing environment image data of a recognition system of the vehicle, wherein the recognition system includes an environmental sensor for detecting a vehicle environment while the vehicle is traveling; providing domain knowledge of the vehicle environment in the form of a trained knowledge graph; and creating the high-resolution environment maps of the vehicle environment by supplementing the environment image data by means of the provided domain knowledge of the trained knowledge graph.

### FIELD

The present invention relates to methods and apparatuses for creating high-resolution environment maps for a vehicle having an autonomous driving function.

### BACKGROUND INFORMATION

Autonomous driving (AD) systems represent the pinnacle of technological innovation in the automotive sector, promising to revolutionize mobility and aiming to dramatically improve safety and efficiency on our roads. A key component essential for the optimal functioning of these systems is high-resolution (HD) maps. These maps provide autonomous vehicles with detailed information about the driving environment, make precise localization possible and support decision-making in complex traffic situations. Despite their importance, HD maps pose a significant hurdle due to their high cost of creation, the challenge of keeping them up to date, and their limited availability in certain regions. In addition, the accuracy of these maps may be limited in dynamic environments where road conditions change rapidly.

In this context, the possibility of creating and continuously updating HD maps with the aid of the perception systems of autonomous vehicles is a promising approach. By having vehicles detect their environment in real time, collect data and use that information to refine the maps, many of the existing challenges could be overcome.

In the scientific paper by Y. Liu, Y. Yuan, Yue Wang Y. Wang, H. Zhao; “VectorMapNet: End-to-End Vectorized HD Map Learning,” arxiv.org/abs/2206.08920, submitted to ICLR 2023, 2022, an approach is described that addresses the problem of creating high-resolution (HD) maps from on-board sensors for autonomous driving. The method uses observations from on-board sensors, such as cameras, lidar or radar, to predict polylines that represent various map elements such as lanes, pedestrian crossings or road dividers. The method substantially consists of three steps: feature extraction, with which image features are extracted using a ResNet CNN, followed by mapping the image into a bird's eye view (BEV) with the aid of inverse perceptual mapping (IPM). Furthermore, LiDAR observations are processed into PointPillars with dynamic voxelization. Image features and lidar features are also linked and further processed by a two-layer CNN. Furthermore, a map element detector is disclosed. A transformer set prediction detector (DETR) recognizes element keypoints, which later form the polylines of the map elements. A deformable attention module, with which each element query has a unique localization, is also used. The prediction head has two MLPs, which decode element queries into element keypoints and their class labels. Furthermore, in a third step, a polyline generator is used. The polyline generator generates detailed geometric shapes of map elements by modeling a distribution over the vertices of the map elements and BEV features.

A further approach is described in the scientific publication of L. Moi, et al., “HDMapGen: Hierarchical Graph Generative Model of High Definition Maps,” IEEE CVPR, 2021.

### SUMMARY

An object of the present invention is to provide at least one improved method and/or apparatus for creating high-resolution environment maps for a vehicle having an autonomous driving function.

The object may be achieved by a method having certain features of the present invention. The object is further achieved by a method have further features of the present invention. The object may also be achieved by an apparatus have certain features of the present invention. The object may further be achieved by an apparatus having further features of the present invention.

According to a first aspect of the present invention, a method for creating high-resolution environment maps (also referred to as HD maps) for a vehicle having an autonomous driving function (also referred to as AD vehicles) is provided. According to an example embodiment of the present invention, the method comprises:
providing environment image data of a recognition system of the vehicle, wherein the recognition system comprises an environmental sensor for detecting a vehicle environment while the vehicle is traveling;
providing domain knowledge of the vehicle environment in the form of a trained knowledge graph; and
creating the high-resolution environment maps of the vehicle environment by supplementing the environment image data by means of the provided domain knowledge of the trained knowledge graph.

According to a second aspect of the present invention, a method for creating high-resolution environment maps for a vehicle having an autonomous driving function is provided. According to an example embodiment of the present invention, the method comprises:
optionally providing the environment image data of a recognition system of the vehicle, wherein the recognition system comprises an environmental sensor for detecting a vehicle environment while the vehicle is traveling;
providing high-resolution environment maps of the vehicle environment;
providing domain knowledge of the vehicle environment in the form of a trained knowledge graph; and
checking the plausibility of and/or supplementing the high-resolution environment maps and/or optionally the environment image data of the vehicle environment by means of the provided domain knowledge of the trained knowledge graph.

It is understood that the steps according to the present invention as well as other optional steps do not necessarily have to be carried out in the order shown, but can also be carried out in a different order. Other intermediate steps can also be provided. The individual steps can also comprise one or more sub-steps without departing from the scope of the method according to the present invention according to the first or second aspect.

According to a third aspect of the present invention, an apparatus for creating high-resolution environment maps for a vehicle having an autonomous driving function is provided. According to an example embodiment of the present invention, the apparatus comprises an evaluation and computing device that is designed to carry out the following steps:
providing environment image data of a recognition system of the vehicle, wherein the recognition system comprises an environmental sensor for detecting a vehicle environment while the vehicle is traveling;
providing domain knowledge of the vehicle environment in the form of a trained knowledge graph; and
creating the high-resolution environment maps of the vehicle environment by supplementing the environment image data by means of the provided domain knowledge of the trained knowledge graph.

According to a fourth aspect of the present invention, an apparatus for creating high-resolution environment maps for a vehicle having an autonomous driving function is provided.

According to an example embodiment of the present invention, the apparatus comprises an evaluation and computing device that is designed to carry out the following steps:
optionally providing the environment image data of a recognition system of the vehicle, wherein the recognition system comprises an environmental sensor for detecting a vehicle environment while the vehicle is traveling;
providing high-resolution environment maps of the vehicle environment;
providing domain knowledge of the vehicle environment in the form of a trained knowledge graph; and
checking the plausibility of and/or supplementing the high-resolution environment maps and/or optionally the environment image data of the vehicle environment by means of the provided domain knowledge of the trained knowledge graph.

The explanations given for the method of the present invention apply accordingly to the apparatus of the present invention. It is understood that linguistic modifications of features formulated for the method can be reformulated for the apparatus in accordance with standard linguistic practice, without such formulations having to be explicitly listed here.

According to an example embodiment of the present invention, the present invention represents map elements by a knowledge graph (KG) and can thus represent a large number of map elements. In addition, the knowledge graph preferably also contains relationships between entities. The knowledge graph can be based on a standardized ontology, e.g., the ASAM OpenX ontology. Therefore, the knowledge graph can represent very detailed map elements that are important for autonomous driving or autonomous driving functions, such as different types of road dividers, road signs, traffic lights, pedestrian paths, parking areas, debris, traffic cones, road construction elements and/or stop lines.

The knowledge graph learns the distribution of map elements preferably from a training dataset of labeled map elements. The training dataset can be derived or provided from datasets for autonomous driving. Incorporating the domain knowledge of the knowledge graph reduces the construction of unrealistic road elements, e.g., straightness of lanes, road dividers, road boundaries, maximum curvature of roads, minimum and/or maximum width of lanes, etc.

The knowledge graph is constructed from a training dataset in order to learn the spatial relationship between map elements and to ensure that only spatially plausible elements are constructed, e.g., that pedestrian crossings start and end at opposite road boundaries, that road dividers are located between two adjacent lanes, and/or that road boundaries are located at the outermost lanes.

According to an example embodiment of the present invention, for the creation of high-resolution environment maps, it is advantageous if a recognition system of the vehicle, for example a lidar sensor, recognizes a vehicle environment and segments and classifies this vehicle environment into individual map elements. In particular, segmentation can be effected pixel by pixel from the detected images. Classification can be effected, for example, in classes such as roads, roadsides, buildings, pedestrian paths, etc. By incorporating the domain knowledge, a plausibility check of the classified map elements can be effected, in particular by assigning element-specific probabilities. For example, contextual knowledge recorded in the knowledge graph, such as whether the vehicle is in a city, on a country road or on a freeway, can also be incorporated. For example, if the vehicle is located on the freeway and a pedestrian crossing is segmented and classified as a map element by the environmental sensor or the segmentation and classification algorithm used, this result can be taken into account in the further map creation by incorporating domain knowledge from the knowledge graph for the further creation of the high-resolution environment map by assigning a low probability for the actual presence of a pedestrian crossing. Thus, the high-resolution environment map created in this way becomes more accurate. Something similar can be effected, for example, by checking the dimensions of recognized road widths or lane widths.

At least the method according to the first aspect of the present invention or the corresponding apparatus of the present invention, which can be part of a system, can be used for the automatic creation of HD maps within a vehicle having an autonomous driving function (also referred to as an AD vehicle). An AD vehicle creates an HD map of each location in which the vehicle travels. The HD maps that are created can preferably also be transmitted online to a location, e.g., a server or a cloud, at or in which the HD maps of a plurality of AD vehicles are received and collected in order to create in particular a complex and highly informative HD map from the plurality of individual HD maps.

At least the method according to the first aspect of the present invention or the corresponding apparatus of the present invention can be used in AD vehicles that have no or only limited access to HD maps. By means of the present method, the AD vehicle creates HD maps immediately or in real time while traveling on the basis of the environment image data of the recognition or perception system and the description system that is provided in the form of the knowledge graph. Thus, an online HD map creation service can be provided for automated vehicles of levels 2 to 5, which may have previously used only SD maps.

At least the method according to the second aspect of the present invention or the corresponding apparatus of the present invention can also be used to provide a more current, more accurate and/or an alternative source of information for the final HD map. Preferably, online HD map creation can be specified for automated vehicles from levels 2 to 5, which, for example, use HD maps that are already stored. In the present case, a second or alternative source of knowledge with HD map information can be provided, which may be more accurate or more up-to-date. Furthermore, the present method can also be used to provide HD maps for areas that are not covered by the stored HD maps or to adapt them by supplementing existing HD maps. It also provides online HD map creation for the creation and supplementation of offline HD maps with full coverage.

According to one example embodiment of the present invention, the environment image data are checked for plausibility and/or supplemented on the basis of standard-definition (SD) topology data of the vehicle environment.

The map of the local topology can consist of a map as typically used in navigation systems, which map contains road layout and driving directions. The map is preferably in the form of standard-definition topology data. The SD map topology is preferably used to provide guidance track topologies, driving directions and other information for creating and checking the HD map.

According to one example embodiment of the present invention, the environment image data are preprocessed by at least one of the following steps:
segmenting image data of the vehicle environment detected by the environmental sensor into elements and classifying the elements into predefined classes that correspond in particular to an ontology of the knowledge graph;
converting the segmented and classified elements of the vehicle environment into a bird's eye view;
extracting individual elements of the vehicle environment on the basis of the segmented image data; and/or
connecting the extracted elements for creating environment maps, in particular by checking the plausibility by means of the domain knowledge provided by the knowledge graph.

The conversion to a bird's eye view can also be effected with the detected image data prior to the segmentation and classification.

In the present case, according to an example embodiment of the present invention, it is proposed to construct an HD map online in an AD vehicle. According to the first and third aspects of the present invention, this construction is preferably effected on the basis of environment image data of the AD perception system, possibly on the basis of an (SD) map of the local topology and on the basis of the domain knowledge of the knowledge graph of the trained map. The AD perception system is preferably used for recognizing moving objects such as vehicles and pedestrians, but also for recognizing map elements such as lanes, pedestrian crossings, etc. The preferred image segmentation is used to divide all elements into defined classes. A local topology map preferably serves as a guide for the creation of HD maps by containing the most important information about the road topology, driving direction, curves, etc. The trained map knowledge graph is used to provide information about typical special, relational, topological, area-dependent and statistical distributions of map elements. It helps to construct HD maps with high accuracy.

The HD map construction process preferably incorporates the individual map element candidates of the recognition or perception system and validates their existence in the subsequent steps. This is preferably done by, in particular, subsequently connecting map elements and a hierarchical check of their existence on the basis of the current location. Temporal information can possibly be used to filter out moving objects such as vehicles or pedestrians from the image data.

The individual map elements are preferably connected to one another on the basis of their type and location as specified by the perception system and preferably on the basis of the information provided by the knowledge graph. Methods such as neural networks, which are capable of processing heterogeneous graphs such as knowledge graphs, can preferably be used to find a compact vector-based representation of traffic scenes. These can be used to calculate a similarity of the proposed HD map with representations of the stored map knowledge graph.

According to one example embodiment of the present invention, creating the high-resolution environment maps of the vehicle environment comprises augmenting the environment maps by means of the domain knowledge provided by the knowledge graph.

The HD map is preferably supplemented by information that is possibly not visible in the image data from the environmental sensor and/or not provided by the perception system. For example, traffic rules, traffic lights or traffic signs usually indicate a stopping region, in which a vehicle should stop if it needs to avoid an accident. This also makes it possible to add information about non-visible road separations. Even at construction sites that comprise both white permanent and yellow temporary overtaking markings, the method or apparatus can thus conclude that there is a valid road separation.

According to one example embodiment of the present invention, the environmental sensor comprises a lidar sensor and/or a radar sensor and/or a camera.

The perception system of the vehicle can comprise, for example, a video camera, a radar sensor, a lidar sensor or other sensors. The vehicle environment can also only be detected by video sensors or video cameras. The perception system recognizes objects in the detected driving scene while the vehicle is driving, and segments the entire image preferably frame by frame into predefined classes, in particular according to the ontology described by the knowledge graph. The elements are also preferably represented in a bird's eye view (BEV), which corresponds to a high-resolution environment map representation.

According to one example embodiment of the present invention, the knowledge graph is trained based on a training dataset of a plurality of driving scenes and/or domain knowledge.

Through training, the knowledge graph preferably learns typical, legal and/or plausible representations of map elements from a training dataset. This helps create more accurate high-resolution (HD) maps. The map knowledge graph is preferably created from a training dataset with a large number of driving scenes. Preferably, an ontology of the map is created. The knowledge graph preferably represents a typical distribution of map elements and their topology. It is preferably used as a guide for the process of online HD map creation.

According to one example embodiment of the present invention, the knowledge graph is trained to establish a spatial relationship between map elements and to ensure that only elements that are plausibly spatially compatible with one another are used for the creation and/or supplementation of the high-resolution environment maps.

According to one example embodiment of the present invention, the knowledge graph comprises domain knowledge about a road type and/or a lane type and/or about a road divider and/or about a road boundary and/or about a pedestrian crossing and/or about a stopping region and/or about traffic signs and/or about traffic lights and/or about directional arrows and/or about poles and/or about barriers and/or about traffic cones and/or about buildings and/or about plants and/or about debris.

By incorporating domain knowledge stored in the trained knowledge graph, the proposed method of the present invention is able to take into account many more map elements than previous approaches. While previous approaches can often only recognize, segment, classify and thus take into account four element types in image data, the proposed method can take into account a large number of map elements by incorporating the domain knowledge of the trained knowledge graph when creating, supplementing or checking the plausibility of high-resolution environment maps. Exemplary map elements include various types of lanes, such as vehicle lanes, bicycle lanes, sidewalks, and parking lanes; various road dividers, such as continuous, double continuous, dashed, distinctly dashed, or time-limited road dividers, or the like; stopping regions, such as those not visible but inferable from the ontology of the knowledge graph; traffic signs, traffic lights, directional arrows painted on the road, poles, barriers, traffic cones, buildings, plants, debris, etc. The proposed approach can possibly also derive traffic rules from the recognized map details, such as right-of-way depending on traffic signs or similar traffic rules.

According to an example embodiment of the present invention, a control device is also provided which is included in a vehicle having an autonomous driving function, and/or a robotic system and/or an industrial machine and can be carried out according to one of the embodiments of the methods of the present invention.

According to an example embodiment of the present invention, a computer program having program code is also provided in order to carry out at least parts of the method according to the present invention in any of its embodiments when the computer program is executed on a computer. In other words, according to the present invention, a computer program (product) comprising commands that, when the program is executed by a computer, cause the computer to carry out the method of the present invention/steps of the method according to the present invention in any of its embodiments.

According to the present invention, a computer-readable data carrier having program code of a computer program is also proposed in order to carry out at least parts of the method according to the present invention in any of its embodiments when the computer program is executed on a computer. In other words, the present invention relates to a computer-readable (memory) medium comprising commands that, when executed by a computer, cause the computer to carry out the method of the present invention/steps of the method according to the present invention in any of its embodiments.

The disclosed embodiments and developments of the present invention can be combined with one another as desired.

Further possible embodiments, developments, and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the embodiments of the present invention. They illustrate embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 is a schematic flow chart of an example method according to the first aspect of the present invention.

FIG. 2 is a schematic flow chart of an example method according to the second aspect of the present invention.

FIG. 3 is a schematic block diagram of an example method according to one embodiment of the present invention.

In the figures, identical reference signs denote identical or functionally identical elements, parts or components, unless stated otherwise.

### DETAILED DESCRIPTION OF EXAMPLE EMBODIMENTS

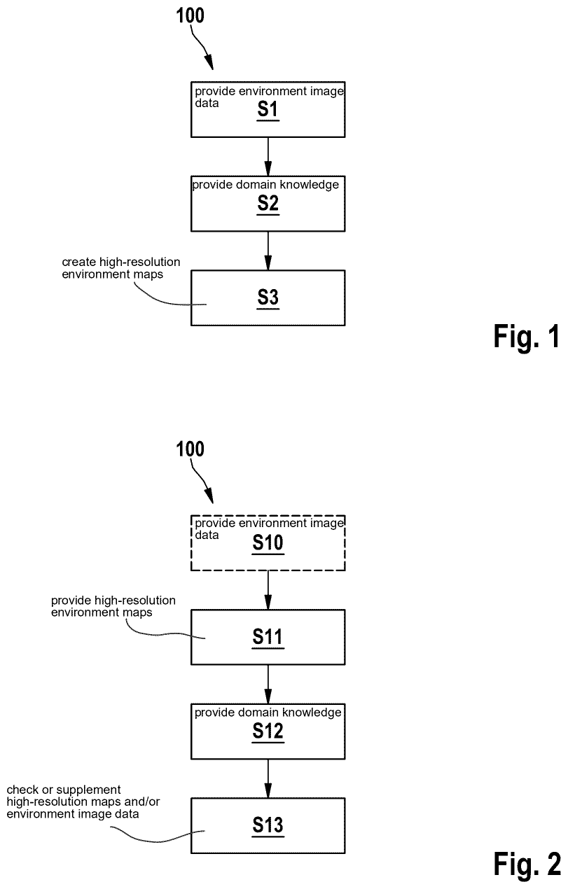

FIG. 1 is a schematic flow chart of a method for creating high-resolution environment maps for a vehicle having an autonomous driving function according to a first aspect.

FIG. 2 is a schematic flow chart of a method for creating high-resolution environment maps for a vehicle having an autonomous driving function according to a second aspect.

In any embodiment, the method according to the first and the second aspect can be carried out at least partially by an apparatus 100 that can comprise, for this purpose, multiple components (not represented in detail), for example one or more provisioning devices and/or at least one evaluation and computing device. It is self-evident that the provisioning device can be designed together with the evaluation and computing device or can be different therefrom. Furthermore, the system can comprise a storage device and/or an output device and/or a display device and/or an input device.

According to the present invention, the computer-implemented method according to the first aspect shown in FIG. 1 comprises at least the following steps:

In a step S1, environment image data of a recognition system of the vehicle are provided, wherein the recognition system comprises an environmental sensor for detecting a vehicle environment while the vehicle is traveling.

In a step S2, domain knowledge of the vehicle environment is provided in the form of a trained knowledge graph.

In a step S3, the high-resolution environment maps of the vehicle environment are created by supplementing the environment image data by means of the provided domain knowledge of the trained knowledge graph.

The computer-implemented method according to the second aspect shown in FIG. 2 comprises at least the following steps:

In an optional step S10, the environment image data of a recognition system of the vehicle are provided, wherein the recognition system has an environmental sensor for detecting a vehicle environment while the vehicle is traveling.

In a step S11, high-resolution environment maps of the vehicle environment are provided.

In a step S12, domain knowledge of the vehicle environment is provided in the form of a trained knowledge graph.

In a step S13, the high-resolution environment maps and/or optionally the environment image data of the vehicle environment are checked for plausibility and/or supplemented by means of the provided domain knowledge of the trained knowledge graph.

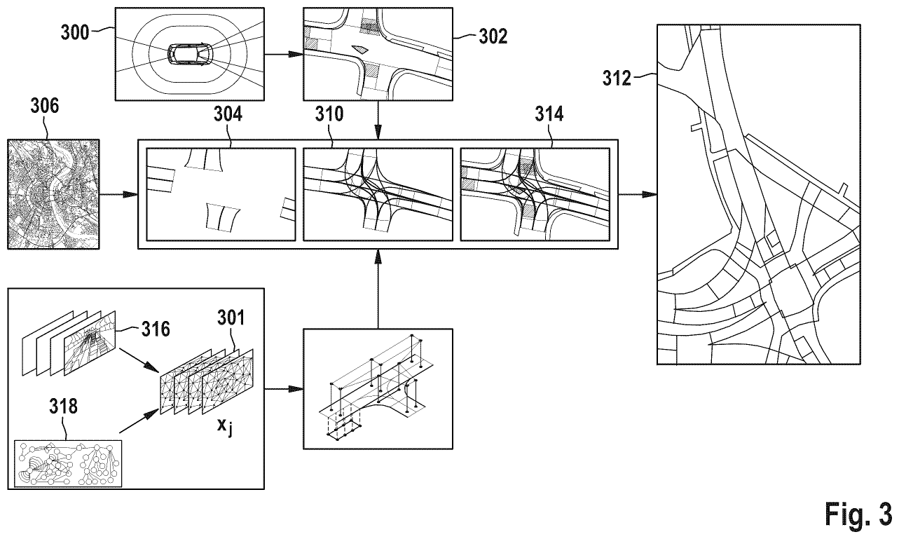

FIG. 3 is a schematic block diagram of a method according to one embodiment.

Image data 300 of a vehicle environment are detected by an environmental sensor, for example a lidar sensor, a radar sensor and/or a camera. Segmenting of the image data 300 of the vehicle environment detected by the environmental sensor into (map) elements and classification of the (map) elements into predefined classes that correspond in particular to an ontology of a knowledge graph 301 are effected. These segmented and classified map elements are preferably converted into a bird's eye view representation 302. Extraction of some characteristic, individual map elements of the vehicle environment is effected on the basis of the image data that have been segmented, classified and converted into a bird's eye view, which is indicated by reference sign 304. The environment image data or the processed image data are checked for plausibility and/or supplemented on the basis of standard-definition topology data 306 of the vehicle environment. The extracted map elements are connected in order to create environment maps 310. This is preferably effected by a plausibility check by means of the domain knowledge provided by the knowledge graph. The creation of the high-resolution environment maps 312 (HD maps) of the vehicle environment comprises augmenting the environment maps 310 by means of the domain knowledge provided by the knowledge graph 301. This augmenting is denoted by reference sign 314.

The knowledge graph 301 is trained based on a training dataset 316 of a plurality of driving scenes and/or domain knowledge 318. The knowledge graph 301 is trained to establish a spatial relationship between map elements and to ensure that only elements that are plausibly spatially compatible with one another are used for the creation and/or supplementation of the high-resolution environment maps 312.

1-14 (canceled)

15. A method for creating high-resolution environment maps for a vehicle having an autonomous driving function, the method comprising the following steps:
providing environment image data of a recognition system of the vehicle, wherein the recognition system includes an environmental sensor for detecting a vehicle environment while the vehicle is traveling;
providing domain knowledge of the vehicle environment in the form of a trained knowledge graph; and
creating the high-resolution environment maps of the vehicle environment by supplementing the environment image data using the provided domain knowledge of the trained knowledge graph.

16. A method for checking the plausibility of and/or supplementing high-resolution environment maps and/or environment image data for a vehicle having an autonomous driving function, the method comprising the following steps:
optionally providing the environment image data of a recognition system of the vehicle, wherein the recognition system includes an environmental sensor for detecting a vehicle environment while the vehicle is traveling;
providing high-resolution environment maps of the vehicle environment;
providing domain knowledge of the vehicle environment in the form of a trained knowledge graph; and
checking the plausibility of and/or supplementing the high-resolution environment maps and/or optionally the environment image data of the vehicle environment using the provided domain knowledge of the trained knowledge graph.

17. The method according to claim 15, wherein the environment image data are checked for plausibility and/or supplemented based on standard-definition topology data of the vehicle environment.

18. The method according to claim 15, wherein the environment image data are preprocessed by at least one of the following steps:
segmenting image data of the vehicle environment detected by the environmental sensor into elements and classifying the elements into predefined classes that correspond to an ontology of the knowledge graph; and/or
converting the segmented and classified elements of the vehicle environment into a bird's eye view; and/or
extracting individual elements of the vehicle environment based on the segmented image data; and/or
connecting the extracted elements for creating environment maps, by checking plausibility using the domain knowledge provided by the knowledge graph.

19. The method according to claim 18, wherein the creating of the high-resolution environment maps of the vehicle environment includes augmenting the environment maps using the domain knowledge provided by the knowledge graph.

20. The method according to claim 15, wherein the environmental sensor includes a lidar sensor and/or a radar sensor and/or a camera.

21. The method according to claim 15, wherein the knowledge graph is trained based on a training dataset of a plurality of driving scenes and/or domain knowledge.

22. The method according to claim 21, wherein the knowledge graph is trained to establish a spatial relationship between map elements and to ensure that only elements that are plausibly spatially compatible with one another are used for the creation and/or supplementation of the high-resolution environment maps.

23. The method according to claim 15, wherein the knowledge graph includes domain knowledge about a road type and/or a lane type and/or about a road divider and/or about a road boundary and/or about a pedestrian crossing and/or about a stopping region and/or about traffic signs and/or about traffic lights and/or about directional arrows and/or about poles and/or about barriers and/or about traffic cones and/or about buildings and/or about plants and/or about debris.

24. An apparatus for creating high-resolution environment maps for a vehicle having an autonomous driving function, the apparatus comprising an evaluation and computing device that is configured to carry out the following steps:
providing environment image data of a recognition system of the vehicle, wherein the recognition system includes an environmental sensor for detecting a vehicle environment while the vehicle is traveling;
providing domain knowledge of the vehicle environment in the form of a trained knowledge graph; and
creating the high-resolution environment maps of the vehicle environment by supplementing the environment image data using the provided domain knowledge of the trained knowledge graph.

25. An apparatus for creating high-resolution environment maps for a vehicle having an autonomous driving function, the apparatus comprising an evaluation and computing device that is configured to carry out the following steps:
optionally providing the environment image data of a recognition system of the vehicle, wherein the recognition system includes an environmental sensor for detecting a vehicle environment while the vehicle is traveling;
providing high-resolution environment maps of the vehicle environment;
providing domain knowledge of the vehicle environment in the form of a trained knowledge graph; and
checking plausibility of and/or supplementing the high-resolution environment maps and/or optionally the environment image data of the vehicle environment using the provided domain knowledge of the trained knowledge graph.

26. A control device for a vehicle having an autonomous driving function and/or for a robotic system and/or for an industrial machine, the control device configured to create high-resolution environment maps for the vehicle and/or the robotic system and/or the industrial machine, the control device configured to perform the following steps:
providing environment image data of a recognition system of the vehicle, wherein the recognition system includes an environmental sensor for detecting an environment of the vehicle and/or the robotic system and/or the industrial machine while the vehicle and/or the robotic system and/or the industrial machine is traveling;
providing domain knowledge of the environment in the form of a trained knowledge graph; and
creating the high-resolution environment maps of the vehicle environment by supplementing the environment image data using the provided domain knowledge of the trained knowledge graph.

27. A non-transitory computer-readable data carrier on which is stored program code of a computer program for creating high-resolution environment maps for a vehicle having an autonomous driving function, the program code, when executed by a computer, causing the computer to perform the following steps:
providing environment image data of a recognition system of the vehicle, wherein the recognition system includes an environmental sensor for detecting a vehicle environment while the vehicle is traveling;
providing domain knowledge of the vehicle environment in the form of a trained knowledge graph; and
creating the high-resolution environment maps of the vehicle environment by supplementing the environment image data using the provided domain knowledge of the trained knowledge graph.
